(19) United States
(12) Patent Application Publication
(10) Pub. No.: US 2026/0317510 A1
(43) Pub. Date: Oct. 15, 2026

(54) MANUFACTURING A WORK PIECE BY INJECTION MOLDING OF A HIGHLY FILLED LCP COMPOSITION

(71) Applicant: PLASTFORMANCE GMBH, Teisendorf (DE)

(72) Inventors: René TIMMROTH, Teisendorf (DE); Helmut AICHER, Teisendorf (DE)

(73) Assignee: PLASTFORMANCE GMBH, Teisendorf (DE)

(21) Appl. No.: 19/688,586

(22) Filed: May 27, 2026

Related U.S. Application Data
(63) Continuation of application No. PCT/EP2024/074712, filed on Sep. 4, 2024.

(30) Foreign Application Priority Data
Nov. 29, 2023 (EP) EP23212933.8

(51) Int. Cl. C08K 3/22; B29C 45/00; B29K 67/00; B29K 105/00; B29K 105/16; B29K 509/00; C08L 67/04

(52) U.S. Cl. CPC C08K 3/22; B29C 45/0001; C08L 67/04; B29K 2067/00; B29K 2105/0079; B29K 2105/16; B29K 2509/00; C08K 2003/2227; C08K 2201/005

(57) ABSTRACT

The present invention relates to a method for manufacturing a work piece by an injection molding process, wherein the injection molding process is carried out using a plastic composite composition comprising a liquid crystal polymer matrix and a high content particulate filler material. The method is suitable for making mechanically stable work pieces having a high thermal conductivity or a similar desirable property by injection molding.

This application is a continuation of PCT/EP2024/074712, filed Sep. 4, 2024, which claims priority to European Patent Application No. EP23212933.8, filed Nov. 29, 2023, both of which are incorporated in their entirety by reference herein.

The invention relates to a method for manufacturing a work piece by an injection molding process, wherein the injection molding process is carried out using a plastic composite composition comprising a thermoplastic polymer matrix and a particulate filler material.

For some applications, a high proportion of particulate filler materials is desirable for compositions of the generic kind. For example, high filler material proportions can lead to work pieces having high thermal conductivity, high density or high screening effect for electromagnetic signals and radiation. Some properties like thermal conductivity take a sharp increase when the proportion of the filler material is close to their tightest packing, where distances between the particles become small and close contact areas between the particles increase. On the other hand, composite compositions with a high proportion of particulate fillers may have a high melt viscosity and hence be difficult to process in methods like injection molding. Additionally, resulting work pieces may have poor mechanical properties.

Prior art documents WO 2017/028939 A1 and WO 2018/141587 A1 disclose plastic composite compositions having high proportions of particulate filler materials, which are suitable for making mechanically stable work pieces having a high thermal conductivity or other desirable properties by injection molding. The compositions rely on a particular additivation to the polymer matrix.

The present invention aims to provide means for making mechanically stable work pieces having similar or even better performance in terms of thermal conductivity or other desirable properties by injection molding, preferably at less or no additivation.

Against this background, the invention proposes a method for manufacturing a work piece by an injection molding process, wherein the injection molding process is carried out using a plastic composite composition comprising a thermoplastic polymer matrix and a particulate filler material, wherein the thermoplastic polymer matrix comprises a thermotropic liquid crystal polymer and that the content of the particulate filler material is 30 vol % or greater, based on the total volume of the plastic composite composition.

The vol % of the particulate filler material relative to the total volume of the plastic composition can easily be converted to wt % when the densities (g/cm³) of the thermoplastic polymer matrix on the one hand and the material forming for the particulate filler material are known. For example, when a liquid crystal polymer having a density of 1.40 g/cm³ a particulate filler material of a material having a density of 4.20 g/cm³ are used, a volume content of 30 vol % particulate filler material would correspond to a weight content of around 56 wt %. To define the present application, using vol % is more appropriate than using wt % simply because the present invention is about the volume fraction within the composition that is occupied by the particulate filler material, or in other words about bringing the content of the filler material close to a level where distances between the particles become small and close contact areas between the particles increase.

Thermotropic liquid crystal polymers (thermotropic LCPs) are polymers, which form liquid crystalline phases (mesophases) when heated above its melting transition point. Mesophases are partially ordered intermediate phases existing between the crystalline solid and isotropic liquid. The liquid crystalline behaviour results from mesogenic groups in the polymer structure, which are usually rod-like or disk-like molecules, such as two or more cyclic and preferably two or more aromatic units.

In a preferred embodiment, the polymer matrix of the invention comprises a thermotropic main chain liquid crystal polymer. These polymers consist of mesogenic groups incorporated into the backbone of the polymer chain.

Within the group of main chain liquid crystal polymers, polyesters are a preferred choice within the present invention. Such materials readily induce orientation in the liquid crystalline state and can produce work pieces with great strength when used in injection molding applications.

Further, within the group of main chain liquid crystal polymers, it can be preferred in the context of the invention to use polymers where the rigid mesogenic groups in the polymer backbone are interrupted by spacers. This leads to a lower melting point and makes the materials easier to process. Mesogenic structures comprising an aromatic unit, like hydroxybenzoic acid compounds or terephthalic acid compounds, can be preferred in the context of the invention. Suitable spacer units include aliphatic spacer units, bent structures (kinks), twisted structures (swivels), or parallel-offset structures (crankshaft). Aliphatic spacer units like ethylene units can be preferred in the context of the invention.

In one embodiment, the liquid crystal polymer has a melting temperature of 350° C. or less, preferably 320° C. or less when determined with DSC according to ASTM D3418-99.

Preferably, the thermoplastic polymer matrix consists of the liquid crystal polymer, or comprises at least 50 wt %, more preferably at least 75 wt %, yet more preferably at least 95 wt % of the liquid crystal polymer.

In one embodiment, the thermoplastic polymer matrix comprises a mixture of the liquid crystal polymer and a second polymer, wherein the second polymer preferably accounts for 5 to 25 wt %, preferably 10 to 15 wt % of the thermoplastic polymer matrix. The second polymer is typically likewise a thermoplastic polymer. A preferred example for the second polymer comprises polyphenylene sulphide (PPS). It has been observed in experiments that this polymer, in conjunction with the liquid crystal polymer, leads to compositions of very good performance.

In one embodiment, the composition consists of the liquid crystal polymer and, if applicable, the second polymer, an comprises no additional additivation. It has been found that the liquid crystal polymer matrix, unlike the base polymer of the compositions presented in WO 2017/028939 A1 and WO 2018/141587 A1, lead to very good results even without additional additivation. It is suspected that this observation stands in connection with an inherently low melt viscosity of liquid crystal polymers.

In one embodiment, the particulate filler material can have a D50 particle size (median particle size) of 200 micrometers or smaller, and a D90 particle size of 500 micrometers or smaller. In one embodiment, the particulate filler material can have a multimodal particle size distribution, at least two different particle types in the form of a fine particle size component and a coarse particle size component. In this context, the fine particle size component can have a D50 particle size of 50 micrometers or smaller, and the coarse particle size component can have a D50 particle size of 250 micrometers or smaller. The amount of the fine particle size component can range from 10 to 90 wt %, based on the total weight of the particulate filler material. All particle sizes are as determined by laser diffraction according to ISO 13320.

In a preferred embodiment, the filler material is a ceramic, metallic or carbon-based filler material. Ceramic filler materials, especially alumina particles, can be preferred. The ceramic, preferably alumina particles can, for example, be calcined, sintered or electrofused particles. In an embodiment, the ceramic, preferably alumina particles can be surface treated. Surface treatments suitable in the context of the invention include metalorganic compound-based surface treatments and fatty acid compound-based surface treatments. These treatments can improve the compatibility of the alumina product with the polymer matrix. Further, to increase compatibility with the polymer matrix, the ceramic, preferably alumina particles can be particles that have been pre-treated with physical processes like, for example, thermal processes carried out under different gas atmospheres.

In one embodiment, the shape of the particles can be essentially spherical, meaning that the average aspect ratio is 1.5:1 or lower, preferably 1.2:1 or lower. In another embodiment, the shape of the particles can be irregular or at least non-spherical. For example, an average aspect ratio of the particles can be 1.5:1 or higher, preferably 2:1 or higher. Preferably, however, the average aspect ratio is below 15:1, preferably below 10:1. Aspect ratios are as determined by analysing SEM images, thereby using the two-dimensional sizes of between 25-50 randomly selected particles in the D30-D90 range.

Examples of particles that can meaningfully be used in the context of the present invention are as described in EP 3 458 509 A1.

In a preferred embodiment, the (absolute) content of the particulate filler material in the composition (% abs) is 40 vol % or greater, based on the total volume of the plastic composite composition. At a content of around 40 vol % an approximately exponential growth in thermal conductivity of work pieces manufactured from the composition has experimentally been observed to set in, vis-à-vis a more linear growth below 35 vol %. A suspected reason for this is that some physical properties of the plastic composite composition are decisively influenced by how close the compositions are able to approximate a density that corresponds to a theoretical packing density, where distances between the particles become small and close contact areas between the particles increase.

Further preferred ranges comprise 45 vol % or greater, 50 vol % or greater, or even 55 vol % or greater. The higher filler contents can, in particular, be used in the context of a multimodal set of particles, which generally has a higher bulk density when compared to a monomodal set of particles of the same D50 particle size.

In some embodiments, the (relative) filler material content in the composition (% rel) can be 40% or greater, preferably 50% or greater and more preferably 60% or greater of a density of the material, which the particles are made of (e.g. alumina has a density of 3.95 g/cm³). The value of rel % can easily be calculated for a particular composition when the densities (g/cm³) of the thermoplastic polymer matrix on the one hand and the material forming for the particulate filler material are known. Notably, as the filler materials are particulate, it is impossible to reach the density of the material, which the particles are made of. Assuming entirely spherical particles of entirely homogenous size, the theoretical maximum would be about 74% relative filler material content (close-packing of equal spheres). Bimodal or multimodal particulate materials can have theoretical maxima that are even higher than 74%, like above 80%. The relative filler material content is a meaningful property of the inventive compositions because some of its physical properties may decisively be influenced by how close the compositions are able to approximate the theoretical maximum, where distances between the particles become small and close contact areas between the particles increase.

The plastic composite composition can be provided to the injection molding machine in pellet form.

The present invention provides the possibility of achieving a high degree of volume filling in a polymer matrix, approaching a theoretical maximum packing density of the filler material particles. The compositions hence approximate certain physical properties of the naked filler material, for example thermal conductivity or magnetic shielding, while allowing standard plastic processing like injection molding.

Further details and advantages of the invention can be understood from the examples and the FIGURE described in the following. In the FIGURES,

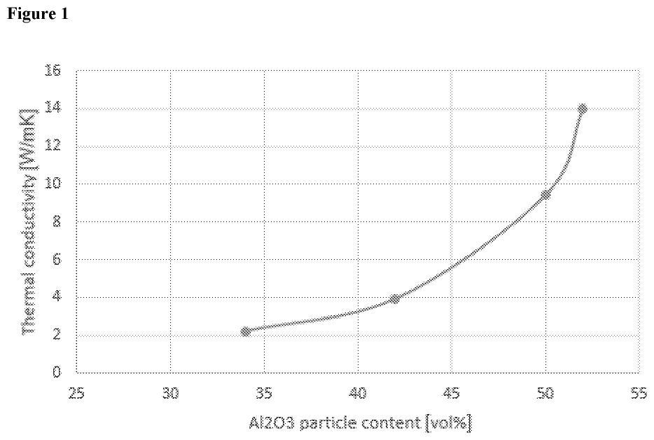

FIG. 1 shows a graph demonstrating the thermal conductivity as a function of the alumina particle content for compositions used according to the invention.

### Example 1

A plastic composite composition was made by mixing 48 vol % of a liquid crystal polymer (LCP) and 52 vol % of alumina particles in a twin screw extruder. The LCP was a thermotropic liquid crystal polyester based on hydroxybenzoic acid (HBA) compound and polyethylene terephthalate (PET). It has a melting point of around 310-320° C. The alumina particles had an average particle size (D50) of 3 micrometers, a D10 value of 0.3 micrometers and a D100 value of smaller 20 micrometers.

Tensile bars (type 1A, test specimen according to DIN EN ISO 527-2) were injection molded from the plastic composite composition thus obtained on a standard injection molding machine.

The isotropic thermal conductivity was measured in accordance with DIN EN ISO 22007-2. The thermal conductivity was 14 W/mK.

### Examples 2-4

Example 1 was repeated with different contents in alumina particles. In Example 2, the alumina particle content was 34 vol %. In Example 3, the alumina particle content was 42 vol %. In Example 4, the alumina particle content was 50 vol %.

Table 1 shows the thermal conductivity as a function of the alumina particle content.

TABLE 1

| | Al₂O₃ particle content | Thermal conductivity | |
|---|---|---|---|
| Example 2 | 34 vol % | 2.2 | W/mK |
| Example 3 | 42 vol % | 3.9 | W/mK |
| Example 4 | 50 vol % | 9.4 | W/mK |
| Example 1 | 52 vol % | 14 | W/mK |

FIG. 1 is a graphic illustration of the data. It can be seen that at around 40 vol %, an exponential rise in thermal conductivity sets in. This demonstrates that the thermal conductivity is not a linear function of the filler particle content, but decisively influenced by how close the compositions approximate a theoretical maximum packing density.

### Comparative Example 1

Example 1 was repeated with the same alumina particles and vol %-fractions, but with a different polymer matrix, namely a polyamide 6 additivated according to WO 2017/028939 A1.

Here, the thermal conductivity was 3 W/mK. It follows that the thermal conductivity of the inventive compositions, at the same volume fraction of alumina particles, is much higher, in the example more than four times as high.

1. A method for manufacturing a work piece by an injection molding process, wherein the injection molding process is carried out using a plastic composite composition comprising a thermoplastic polymer matrix and a particulate filler material, wherein
the thermoplastic polymer matrix comprises a thermotropic liquid crystal polymer and that the content of the particulate filler material is 30 vol % or greater, based on the total volume of the plastic composite composition.

2. The method of claim 1, wherein the liquid crystal polymer is a main chain liquid crystal polymer, preferably a polyester-based main chain liquid crystal polymer.

3. The method of claim 2, wherein rigid mesogenic groups in the polymer backbone are interrupted by spacers.

4. The method of claim 1, wherein the liquid crystal polymer has a melting temperature of 350° C. or less when determined with DSC according to ASTM D3418-99.

5. The method of claim 1, wherein the thermoplastic polymer matrix comprises at least 50 wt % of the liquid crystal polymer.

6. The method of claim 1, wherein the thermoplastic polymer matrix comprises a mixture of the liquid crystal polymer and a second polymer wherein the second polymer accounts for 5 to 25 wt % of the thermoplastic polymer matrix.

7. The method of claim 1, wherein the particulate filler material have a D50 particle size of 20 micrometers or less and/or a D90 particle size of 500 micrometers or less, as determined by laser diffraction according to ISO 13320.

8. The method of claim 1, wherein the particulate filler material have a multimodal particle size distribution, comprising at least two different particle types in the form of a fine particle size component and a coarse particle size component.

9. The method of claim 8, wherein the fine particle size component has a D50 particle size of 50 micrometers or less and/or the coarse particle size component has a D50 particle size of 250 micrometers or less, as determined by laser diffraction according to ISO 13320, and/or wherein the amount of the fine particle size component is from 10 to 90 wt %, based on the total weight of the particulate filler material.

10. The method of claim 1, wherein the particulate filler material is a ceramic, metallic or carbon-based filler material.

11. The method of claim 1, wherein the particulate filler material are alumina particles, which are optionally surface treated.

12. The method of claim 1, wherein the content of the particulate filler material is 40 vol % or greater, based on the total volume of the plastic composite composition.

13. The method of claim 1, wherein a relative content of the particulate filler material is 40% or greater, preferably 50% or greater of a density of the material which the particles are made of.

14. The method of claim 2, wherein rigid mesogenic groups in the polymer backbone are interrupted by spacers that are selected from aliphatic spacer units, bent structures, twisted structures or parallel-offset structures.

15. The method of claim 1, wherein the liquid crystal polymer has a melting temperature of 350° C. or less when determined with DSC according to ASTM D3418-99.

16. The method of claim 1, wherein the thermoplastic polymer matrix comprises at least 95 wt % of the liquid crystal polymer.

17. The method of claim 1, wherein the thermoplastic polymer matrix comprises a mixture of the liquid crystal polymer and a second polymer that is polyphenylene sulphide, wherein the second polymer accounts for 10 to 15 wt % of the thermoplastic polymer matrix.

18. The method of claim 1, wherein the filler material is a ceramic filler material.

19. The method of claim 1, wherein the content of the particulate filler material is 50 vol % or greater, based on the total volume of the plastic composite composition.

20. A workpiece produced by the method of claim 1.
